(19) United States
(12) Patent Application Publication
(10) Pub. No.: US 2021/0198768 A1
(43) Pub. Date: Jul. 1, 2021

(54) Selective Extraction of Metals From Complex Inorganic Sources

(71) Applicant: Lixivia, Inc., Santa Barbara, CA (US)

(72) Inventor: Michael D. Wyrsta, Santa Barbara, CA (US)

(21) Appl. No.: 17/058,773

(22) PCT Filed: May 30, 2019
(86) PCT No.: PCT/US2019/034552

§ 371 Date: Nov. 25, 2020

Related U.S. Application Data
(60) Provisional application No. 62/678,177, filed on May 30, 2018.

(51) Int. Cl. C22B 7/00; C22B 21/00; C22B 26/20; C22B 3/22; C22B 3/44; C22B 7/04

(52) U.S. Cl. CPC C22B 7/007; C22B 21/0023; C22B 7/04; C22B 3/22; C22B 3/44; C22B 26/20

(57) ABSTRACT

Compositions and methods are provided that permit both recovery of at least two metals from industrial waste materials and control of the degree of relative recovery between the two metals. Industrial waste is initially treated with an acid and mixed for a defined period of time, and the extracted metals recovered from the resulting supernatant in subsequent steps. Surprisingly, the duration of this initial stirring period has been found to impact the relative degree of recovery of the two metals in a non-linear fashion.

This application claims the benefit of U.S. Provisional Patent Application No. 62/678,177, filed on May 30, 2018. These and all other referenced extrinsic materials are incorporated herein by reference in their entirety. Where a definition or use of a term in a reference that is incorporated by reference is inconsistent or contrary to the definition of that term provided herein, the definition of that term provided herein is deemed to be controlling.

### FIELD OF THE INVENTION

The field of the invention is extraction of metals from complex inorganic sources, in particular industrial waste.

### BACKGROUND

The following description includes information that may be useful in understanding the present invention. It is not an admission that any of the information provided herein is prior art or relevant to the presently claimed invention, or that any publication specifically or implicitly referenced is prior art.

There is a long-standing need to efficiently and cost-effectively recover commercially valuable metals from low yield sources, such as industrial waste and mine tailings. Such sources are, however, complex inorganic source materials that present significant challenges to the development of process that are sufficiently selective in regards to recovery of the desired metal and industrial practicality. Historically, it has been desirable to recover alkaline earth elements, copper, aluminum, and boron group elements, which can occur together in complex inorganic source materials. Applications of these commercially important metals also vary widely, and include uses as dopants in electronic components, structural materials, and in the production foods and pharmaceuticals.

Methods of isolating of calcium from minerals, such as limestone, have been known since ancient times. In a typical process limestone is calcined or otherwise roasted to produce calcium oxide (CaO), or quicklime. This material can be reacted with water to produce calcium hydroxide (Ca(OH)₂), or slaked lime. Calcium hydroxide, in turn, can be suspended in water and reacted with dissolved carbon dioxide (CO₂) to form calcium carbonate (CaCO₃), which has a variety of uses. Approaches that have been used to isolate other members of this family of elements often involve the production of insoluble hydroxides and oxides using elevated temperatures or strong acids. Such approaches, however, are not suitable for many sources of alkaline earth elements (such as steel slag), and are not sufficiently selective.

Hydrometallurgy can also be used to isolate metals from a variety of minerals, ores, and other sources. Typically, raw source material is crushed and pulverized to increase the surface area prior to exposure to the solution (also known as a lixiviant). Suitable lixiviants solubilize the desired metal, and leave behind undesirable contaminants. Previously known methods of hydrometallurgy have several problems. A single lixiviant may not provide the desired level of selectivity, necessitating the use of complex and expensive downstream methods for recovery of the desired metal. Similarly, the expense of lixiviant components, and difficulties in adapting such techniques to current production plants, has limited their use.

Approaches have been devised to address these issues. United States Patent Application No. 2004/0228783 (to Harris, Lakshmanan, and Sridhar) describes the use of magnesium salts (in addition to hydrochloric acid) as a component of a highly acidic lixiviant used for recovery of other metals from their oxides, with recovery of magnesium oxide from the spent lixiviant by treatment with peroxide. All publications herein are incorporated by reference to the same extent as if each individual publication or patent application were specifically and individually indicated to be incorporated by reference. Where a definition or use of a term in an incorporated reference is inconsistent or contrary to the definition of that term provided herein, the definition of that term provided herein applies and the definition of that term in the reference does not apply. Such highly acidic and oxidative conditions, however, may not be adequately selective and present numerous production and potential environmental hazards that limit their utility. In an approach disclosed in U.S. Pat. No. 5,939,034 (to Virnig and Michael), metals are solubilized in an ammoniacal thiosulfate solution and extracted into an immiscible organic phase containing guanidyl or quaternary amine compounds. Recovery of the desired metal, however, required subjecting the organic phase to an additional selective step (i.e. electroplating).

A similar approach is disclosed in U.S. Pat. No. 6,951,960 (to Perraud) in which metals are extracted from an aqueous phase into an organic phase that contains an amine hydrochloride. The organic phase is then contacted with a chloride-free aqueous phase that extracts metal chlorides from the organic phase. Applicability to alkaline earth and boron group elements is not clear, however, and the disclosed methods necessarily involve the use of expensive and potentially toxic organic solvents.

In a related approach, European Patent Application No. EP1309392 (to Kocherginsky and Grischenko) discloses a membrane-based method in which copper is initially complexed with ammonia or organic amines. The copper:ammonia complexes are captured in an organic phase contained within the pores of a porous membrane, and the copper is transferred to an extracting agent held on the opposing side of the membrane. Such an approach, however, requires the use of complex equipment, and processing capacity is necessarily limited by the available surface area of the membrane.

Metals such as iron and aluminum have been recovered from materials obtained during oil recovery by solvation using high concentration (e.g. 2M) of strong acids to solubilize the metals, followed by precipitation with an organic aminophosphonic acid (see U.S. Pat. No. 4,758,414, to Gifford et al). Unfortunately both high initial concentrations of aluminum and large excesses of the organic aminophosphonic acid are required for effective precipitation of the solvated metal. It is also not clear if the process is selective.

Similarly, Canadian Patent Application CA 1201422A (to Fahn and Bukl) describes the recovery of iron and aluminum from acidic solution through the addition of an alkaline earth, which results in coprecipitation of aluminum hydroxide and ferric oxide. Aluminum is selectively solvated from this precipitate using sodium hydroxide and subsequently recovered as a crystalline zeolite by treatment with sodium silicate.

Thus, there is still a need for efficient and scalable methods that provide selective recovery of metals, particularly aluminum, from complex inorganic sources.

### SUMMARY OF THE INVENTION

The inventive subject matter provides compositions, systems, and methods in which two or more metals are recovered sequentially from a complex inorganic waste. Mixing time following an initial addition of acid to the complex inorganic waste is controlled in order to control the product distribution of the recovered metals.

One embodiment of the inventive concept is a method of controlling the distribution between first and second metal products recovered from a complex inorganic source by contacting the complex inorganic source comprising the first metal with an acid to form a first suspension, mixing the first suspension for a period of time, and upon completion of the period of time separating the first suspension into a first filtrate and a first solid residue. Suitable acids have a pKa below 5.

The first filtrate is then contacted with a first precipitating agent to form a second suspension, which is separated into a second filtrate and a second solid residue. The second solid residue includes the first metal. Suitable first precipitating agents include first precipitating agent is selected from the group consisting of an organic acid, oxalic acid, organic amines, ethanolamine, ethanolamine salts, ammonia, and ammonium salts. The second filtrate is then contacted with a second precipitating agent to form a third suspension; which is separated into a third filtrate and a third solid residue (which includes the second metal. Suitable second precipitating agents include CO₂, carbonic acid, a carbonate salt, a bicarbonate salt, a phosphate salt, a sulfate salt, and oxalic acid. In some embodiments the first solid residue is additionally processed to recover additional metals that are different from the first and second metals.

The period of time utilized for stirring following the initial addition of acid is selected to provide a desired recovery distribution between the first metal (e.g. aluminum, for example in the form of an alumina-containing gel) and the second metal (e.g. calcium). When the period of time is from 15 minutes to 25 minutes the distribution of recovered metals is skewed towards the first metal. When the period of time exceeds 25 minutes the distribution of recovered metals is skewed towards the second metal.

Suitable complex inorganic sources for methods of the inventive concept can be industrial wastes, such as blast furnace slag, ladle slag, basic oxygen furnace slag, desulfurization slag, and/or aluminum-rich ores and wastes, or mixtures thereof.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWINGS

FIG. 1: FIG. 1 schematically depicts a typical process of the inventive concept.

FIG. 2: FIG. 2 shows selective recovery of aluminum and calcium (in the form of pure calcium carbonate or PCC) as a function of stirring time following acid addition in a method of the inventive concept.

### DETAILED DESCRIPTION

The following description includes information that may be useful in understanding the present invention. It is not an admission that any of the information provided herein is prior art or relevant to the presently claimed invention, or that any publication specifically or implicitly referenced is prior art.

The inventive subject matter provides apparatus, systems and methods in which one or more metals are selectively extracted from a complex inorganic source. Suitable inorganic sources include industrial waste that is normally discarded, such as steel slag, ladle slag, and blast furnace slag. The inventors have found that treatment of such materials with suitable acids and weak bases permits selective extraction and subsequent precipitation of various metals (for example, in the form of metal salts).

In some embodiments, the numbers expressing quantities of ingredients, properties such as concentration, reaction conditions, and so forth, used to describe and claim certain embodiments of the invention are to be understood as being modified in some instances by the term “about.” Accordingly, in some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable. The numerical values presented in some embodiments of the invention may contain certain errors necessarily resulting from the standard deviation found in their respective testing measurements.

The recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all Markush groups used in the appended claims.

In some embodiments of the inventive subject matter the complex inorganic source can be an aluminum containing industrial waste product, such as a slag. Numerous industrial processes produce slags as waste products. For example, iron production generates blast furnace slag (BF slag), whereas steel production generates ladle slag, basic oxygen furnace (BOF) slag, and/or desulfurization slag. Such slags have complex and varying contents, depending on the raw materials used and the processes applied. Typical compositions of blast furnace (BF) slag, ladle (LMF) slag, and basic oxygen furnace (BOF) slag are shown below in Table 1.

TABLE 1
Typical Weight Percent Composition Values

| Component | BOF slag | LMF slag | BF slag |
|---|---|---|---|
| SiO₂ | 11.80 | 5.60 | 33.80 |
| Al₂O₃ | 4.90 | 29.80 | 13.40 |
| Fe₂O₃ | 29.70 | 2.10 | 0.40 |
| MgO | 9.58 | 5.70 | 7.40 |
| CaO | 35.50 | 53.50 | 41.70 |
| Na₂O | 0.05 | 0.26 | |
| K₂O | 0.03 | 0.03 | |
| TiO₂ | 0.35 | 0.17 | |
| P₂O₅ | 0.50 | | |
| MnO | 3.78 | 0.30 | 0.30 |
| Cr₂O₃ | 0.25 | | |
| V₂O₅ | 0.15 | | |
| Total | 96.59 | 97.46 | 97.00 |

In a typical process of the inventive concept such slag materials can be initially processed by size reduction. For example, a slag to be processed can be ground, pulverized, or milled to provide a particulate starting material. Such treatment increases reactive surface area and can facilitate handling (e.g. by facilitating flow). Such particles can be of any suitable configuration, such as granular, cuboidal, spherical, and/or irregular. In some embodiments particles are present in a variety of different configurations. Suitable particle sizes can range from about 5 μm to about 5 mm, and preferably range from about 10 μm to about 1 mm. In some embodiments slags from different sources can be processed and combined, for example after size reduction, to form a mixed raw material.

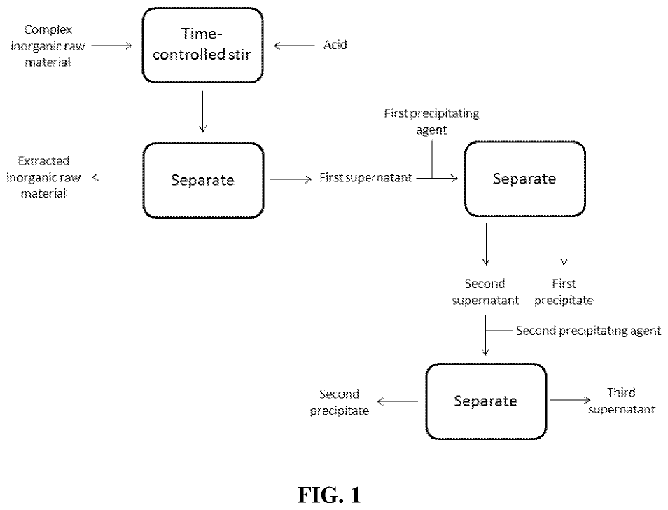

A typical process of the inventive concept is shown in FIG. 1. As shown, a complex inorganic raw material (e.g. slag resulting from an iron or steel-making process) is contacted with an acid and mixed for a controlled period of time. Suitable acids can have a pKₐ of less than 7, less than 6, less than 5, less than 4, less than 3, less than 2, less than 1, or between these values. Mixing can be accomplished by any suitable means, including stirring, tumbling, and agitation. A subsequent separation step separates the solid extracted raw material from a first supernatant or filtrate that includes the metals to be recovered. The duration of this initial mixing period can be selected to control the relative amounts of such metals that are recovered by further processing of this first supernatant. The extracted raw material, which is now enriched in metals not solvated by acid treatment, can be further processed to recover additional valuable metals.

The first supernatant is treated with a first precipitant, resulting in the generation of a first precipitate or similar solid or semi-solid product (e.g. a gel). A subsequent separation step separates this solid product, which contains the first metal to be recovered, from a second supernatant. This second supernatant undergoes further processing to recover a second metal. Addition of a second precipitating agent to the second supernatant generates a second precipitate or similar solid product, which includes the second metal to be recovered. A subsequent separation step separates this second precipitate or solid product from a third supernatant. In some embodiments this third supernatant can be subsequently processed to recover additional metals.

Surprisingly, the Inventors have found that controlling the time spent in the initial mixing/acid extraction of the raw material alters the metal composition of the resulting first supernatant. For example, by controlling the initial mixing or stirring time to within a specific time interval the recovery of aluminum from a steel slag can be increased relative to the recovery of calcium in subsequent steps. If increased recovery of calcium relative to aluminum is desired this can be achieved using the same raw material and extraction chemistry by utilizing an initial mixing or stirring time that is outside of this window (e.g. extending beyond it). Furthermore, Inventors have surprisingly found that the response to mixing time is non-linear, with recovery of some metals peaking within a defined mixing time window rather than simply increasing over time.

In a typical process a raw material (for example, a size-reduced slag) can be treated with an acid. Suitable acids can have a pKa of less than about 5. Suitable acids include acetic acid, propionic acid, hydrochloric acid, hydrobromic acid, nitric acid, and sulfuric acid. During such treatment the acid can be provided as a solution (for example 0.1%, 1%, 10%, 20%, 30%, 40%, or greater than 40% by weight) and added to a suspension of the raw material gradually (for example, in a dropwise manner), preferably while mixing. Such a dropwise addition can be controlled to be performed over a desired period of time, for example 5 minutes, 10 minutes, 20 minutes, 30 minutes, 45 minutes, and hour, or more than an hour. Such an acid can be selected and/or added to provide a final concentration suitable for selective extraction, for example to a final concentration of about 0.05%, 0.5%, 5%, 6%, 7%, 8%, 9% 10% 12%, 15%, 20%, or more than 20% by weight. Following final addition of the acid the acidified suspension can be mixed for a period of time ranging from 1 minute to 2 hours or more.

Surprisingly, the inventors have found that the selectivity of the overall metal recovery process can be modulated by controlling the post acid addition mixing time. In a preferred embodiment the acid is allowed to react with the suspended raw material at its final concentration for from about 20 minutes to about an hour.

Following acid treatment the resulting slurry is separated into a liquid fraction (i.e. a first filtrate or supernatant) and a solids fraction. This can be accomplished by any suitable means, including settling, filtration, and centrifugation. In preferred embodiments the solids portion can be washed at least once, and the washes collected. The solids portion, comprising acid-extracted raw material, can be set aside for further processing (for example, recovery of non-solvated metals), utilized as fill (for example in building materials), or discarded. It should be appreciated that extraction of certain metals by the acid treatment step can leave the treated solids fraction relatively enriched in non-extracted metals that can be of commercial value. Such non-extracted metals can be recovered from such a treated solids fraction in subsequent steps, for example by solvation followed by precipitation, electrodeposition, etc.

The first supernatant and the washes can be pooled to provide a mother liquor, which is subsequently treated with a precipitating agent, for example an organic acid (such as oxalic acid) or a weak base. Suitable weak bases include organic amines, such as monethanolamine. Other weak bases, including other organic amines and ammonia, are also contemplated. The amount of precipitating agent added can range from 1% to 50% by weight of the mother liquor. Such addition can be as a single aliquot, two or portions, or gradually (for example, dropwise). The mother liquor/precipitating agent mixture can be mixed (for example, by stirring) during or following the addition of the precipitating agent. Such mixing can be merely sufficient to blend these components or can extend for a period of time (for example about 5, 10, 15, 20, or 30 minutes) following final addition of the precipitating agent.

Addition of this first precipitating agent can result in the formation of a solid, semi-solid, or non-liquid phase containing a desired metal, which is separated from a liquid portion of the mixture (i.e. second supernatant) following addition of the first precipitating agent. Such a solid phase can be a crystalline precipitate, a flocculent precipitate, a gel, or a combination of these. In a preferred embodiment this first non-liquid phase is a gel or gelatinous solid. Separation can be accomplished by any suitable means, including filtration, centrifugation, or decanting. The separated non-liquid phase can be washed and the washing added to the separated liquid portion.

As noted above, suitable precipitating agents for this initial precipitation step include weak bases, such as amines. Suitable amines of the inventive concept have the general formula shown in Compound 1, where N is nitrogen, H is hydrogen, R₁ to R₃ can be an organic (i.e. carbon-containing) group or H, and X is a counterion (i.e., a counter anion).

Ny,R₁,R₂,R₃,H-Xz

### Compound 1

Suitable counterions can be any form or combination of atoms or molecules that produce the effect of a negative charge. Counterions can be halides (for example fluoride, chloride, bromide, and iodide), anions derived from mineral acids (for example nitrate, phosphate, bisulfate, sulfate, silicates), anions derived from organic acids (for example carboxylate, citrate, malate, acetate, thioacetate, propionate and, lactate), organic molecules or biomolecules (for example acidic proteins or peptides, amino acids, nucleic acids, and fatty acids), and others (for example zwitterions and basic synthetic polymers). For example, monoethanolamine hydrochloride (MEA.HCl, HOC₂H₄NH₃Cl) conforms to Compound 1 as follows: one nitrogen atom (N₁) is bound to one carbon atom (R₁=C₂H₅O) and 3 hydrogen atoms (R₂, R₃ and H), and there is one chloride counteranion (X₁=Cl—). Compounds having the general formula shown in Compound 1 can have a wide range of acidities, and can be selected on the basis of its acidity.

Amines suitable for use as an initial precipitating agent in methods of the inventive concept can have a pKa of about 7 or about 8 to about 14, and can include protonated ammonium salts (i.e., not quaternary). Examples of suitable amines include weak bases such as ammonia, nitrogen containing organic compounds (for example monoethanolamine, diethanolamine, triethanolamine, morpholine, ethylene diamine, diethylenetriamine, triethylenetetramine, methylamine, ethylamine, propylamine, dipropylamines, butylamines, diaminopropane, triethylamine, dimethylamine, and trimethylamine), low molecular weight biological molecules (for example glucosamine, amino sugars, tetraethylenepentamine, amino acids, polyethyleneimine, spermidine, spermine, putrescine, cadaverine, hexamethylenediamine, tetraethylmethylenediamine, polyethyleneamine, cathine, isopropylamine, and a cationic lipid), biomolecule polymers (for example chitosan, polylysine, polyornithine, polyarginine, a cationic protein or peptide), and others (for example a dendritic polyamine, a polycationic polymeric or oligomeric material, and a cationic lipid-like material), or combinations of these. In some embodiments of the inventive concept the amine can be monoethanolamine, diethanolamine, or triethanolamine, which in cationic form can be paired with nitrate, bromide, chloride or acetate anions. In other embodiments of the inventive concept the amine can be lysine or glycine, which in cationic form can be paired with chloride or acetate anions. In a preferred embodiment of the inventive concept the amine is monoethanolamine, which in cationic form can be paired with a chlorine anion.

Such amines can range in purity from about 50% to about 100%. For example, an amine of the inventive concept can have a purity of about 50%, about 55%, about 60%, about 65%, about 70%, about 75%, about 80%, about 85%, about 90%, about 95%, about 97%, about 99%, or about 100%. In a preferred embodiment of the inventive concept the amine is supplied at a purity of about 90% to about 100%.

Inventors further contemplate that zwitterionic species can be used as an initial or first precipitating agent, and that such zwitterionic species can form cation/counterion pairs with two members of the same or of different molecular species. Examples include amine containing acids (for example amino acids and 3-aminopropanoic acid), chelating agents (for example ethylenediaminetetraacetic acid and salts thereof, ethylene glycol tetraacetic acid and salts thereof, diethylene triamine pentaacetic acid and salts thereof, and 1,2-bis(o-aminophenoxy)ethane-N,N,N′,N′-tetraacetic acid and salts thereof), and others (for example betaines, ylides, and polyaminocarboxylic acids).

Amines for use as an initial or first precipitating agent can be selected to have minimal environmental impact. The use of biologically derived amines, such as glycine, is a sustainable practice and has the beneficial effect of making processes of the inventive concept more environmentally sound. In addition, it should be appreciated that some organic amines, such as monoethanolamine, have a very low tendency to volatilize during processing. In some embodiments of the inventive concept an organic amine can be a low volatility organic amine (i.e., having a vapor pressure less than or equal to about 1% that of ammonia under process conditions). In preferred embodiments of the inventive concept the organic amine is a non-volatile organic amine (i.e., having a vapor pressure less than or equal to about 0.1% that of ammonia under process conditions). Capture and control of such low volatility and non-volatile organic amines requires relatively little energy and can utilize simple equipment. This reduces the likelihood of such low volatility and non-volatile amines escaping into the atmosphere and advantageously reduces the environmental impact of their use.

Following removal of the non-liquid phase resulting from addition of a precipitating agent (for example, a weak base) to the mother liquor, the recovered second supernatant (which can include washings from the non-liquid phase) can be treated with a second precipitating agent, which can cause formation of a second precipitate that includes a second desired metal (for example, in the form of an insoluble or partially insoluble salt). Suitable precipitants include carbon dioxide, sulfate salts, phosphate salts, and/or organic acids (for example, oxalic acid). In a preferred embodiment the second precipitating agent is CO₂, which can be provided in the form of a gas, carbonic acid, carbonate salt, or bicarbonate salt. Such a second precipitating agent can be added as the reaction mixture is monitored to determine when an appropriate amount of second precipitating agent has been added. For example, CO₂ can be added and the pH of the reaction mixture monitored to ensure that the pH is below about 7.5, 8, 8.5, 9, 9.5, or 10, or intermediate between two of those values. In other embodiments a second precipitating agent can be added over a period of time (for example, about 5, 10, 15, 20, 30, or more than 30 minutes) after a target pH has been achieved by other means. The resulting second precipitate, which can include one or more additional commercially valuable metals in the form of a salt(s), can be recovered by separation from the solution phase of the reaction mixture by any suitable means (for example, filtration, settling, and/or centrifugation), optionally washed, and dried. In some embodiment a third supernatant resulting from the addition of the second precipitating agent can be further processed to recovery additional valuable materials or metals.

One should appreciate that the disclosed methods provide many advantageous technical effects including improved selectivity in the recovery of metals from complex inorganic mixtures, such as industrial waste.

The following discussion provides many example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

In one example of a process of the inventive concept, 10 grams of LMF slag having an average diameter of 250 μm to 500 μm was suspended in 50 g of deionized water in a 125 mL beaker. To that beaker 17 grams of 37% HCl was added dropwise over the course of 40 minutes. The resulting suspension was stirred for an additional 40 minutes following the addition of HCl. Once stirring was complete the slurry was filtered, washed, the combined washes were added to the filtrate to provide a mother liquor filtrate. Eleven grams of monoethanolamine (MEA) was added to the mother liquor and the resulting solution stirred for 10 minutes. A gel (containing aluminum) formed, which was isolated by filtration and washed. The remaining liquid filtrate was then carbonated using pure CO₂ gas until the pH was below 8 for 15 minutes. The white precipitate (PCC, i.e. calcium carbonate) was filtered from solution, washed and dried. Typical results from treatment of LMF slag are shown below in Table 2.

TABLE 2
LMF Slag

| | | | | | | | | | |
|---|---|---|---|---|---|---|---|---|---|
| Slag particle size | 250-500 | 250-500 | 250-500 | 250-500 | 250-500 | 250-500 | 250-500 | 106-250 | 53-106 |
| (μm) | | | | | | | | | |
| HCl addition time | 15 | 10 | 44 | 27 | 38 | 13 | 42 | 42 | 41 |
| (min) | | | | | | | | | |
| Stir time after HCl | 5 | 10 | 10 | 20 | 40 | 40 | 40 | 40 | 40 |
| addition (min) | | | | | | | | | |
| Slag residue (g) | 7.97 | 8.86 | 3.51 | 8.93 | 8.16 | 9.13 | 3.09 | 2.23 | 1.59 |
| Gel/precipitate after | | | 3.22 | | | | 4.23 | 4.67 | 4.98 |
| addition of MEA (g) | | | | | | | | | |
| PCC (g) | 3.93 | 3.90 | 3.98 | 4.12 | 4.50 | 3.73 | 4.14 | 4.13 | 4.30 |

In another example of a process of the inventive concept, 10 grams of BF slag having an average size of 250 μm to 500 μm was suspended in 50 grams of deionized water in a 125 mL beaker. To that beaker 17 grams of 37% HCl was added dropwise over the course of 40 minutes. The resulting suspension was allowed to stir for an additional 40 minutes after the final addition of HCl. Afterwards the slurry was filtered and the solid fraction washed. Washes were combined with the filtrate to form a mother liquor. Eleven grams of monoethanolamine was added to this mixture and the resulting solution was stirred for 10 minutes. A gel formed, which was removed by filtration and washed. The remaining liquid filtrate was then carbonated using pure CO₂ gas until the pH was less than 8 for 15 minutes. The resulting white precipitate was filtered from solution, washed and dried. Typical results from treatment of BF slag are shown in Table 3.

TABLE 3
BF Slag

| | | | | | | |
|---|---|---|---|---|---|---|
| Slag particle size | 250- | 250- | 250- | 250- | 106- | 53- |
| (μm) | 500 | 500 | 500 | 500 | 250 | 106 |
| HCl addition time | 40 | 40 | 40 | 40 | 40 | 40 |
| (min) | | | | | | |
| Stir time after HCl | 40 | 5 | 10 | 20 | 40 | 40 |
| addition (min) | | | | | | |
| Slag residue (g) | 6.02 | 4.99 | 4.95 | 4.83 | 5.88 | 6.07 |
| Gel/precipitate | 2.60 | 3.83 | 3.42 | 4.90 | 2.57 | 2.01 |
| after addition | | | | | | |
| of MEA (g) | | | | | | |
| PCC (g) | 2.52 | 2.09 | 2.30 | 1.93 | 2.50 | 2.83 |

Inventors have found that the initial gel or precipitate generated by the initial addition of a precipitating agent (for example, a weak base) can include commercially valuable metals (for example aluminum in the form of alumina). Similarly, inventors have found that the subsequent addition of a precipitant (for example, CO₂) to the residual liquid can generate a second precipitate that includes a different metal of commercial value (for example, calcium in the form of calcium carbonate). Surprisingly, the ratio of these products can be modulated and/or controlled by post-HCl addition stir time (i.e. reproportionation occurs).

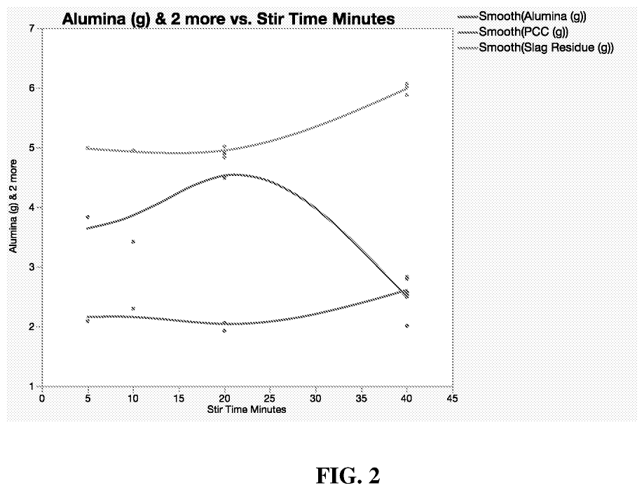

Inventors found that increasing stirring time increased the ultimate calcium carbonate yield and reduced alumina yield, whereas reduced stir times favored recovery of alumina (see FIG. 2). Note that alumina selectivity increases with increasing stir time initially, reaches a maximum (in this example, at approximately 20 minutes), and then decreases with continued stirring. On the other hand, calcium (e.g. calcium carbonate) selectivity increases with increased stirring time, in this example showing increased recovery compared to recovery of alumina after about 20 minutes of stirring. Surprisingly the amount of slag residue was also found to increase after about 20 minutes of stirring, indicating that calcium selectivity is increased relative to both alumina and other slag components on extended (e.g. greater than about 20 minutes) stirring.

In some embodiments of the inventive concept the order of precipitation described above can be reversed. For example, reagents (for example, an organic acid such as oxalic acid) can be added that result in the initial precipitation of calcium. Other metals of commercial value, for example aluminum (e.g. in the form of alumina) can then be subsequently precipitated or otherwise separated from the remaining solution.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refer to at least one of something selected from the group consisting of A, B, C, . . . and N, the text should be interpreted as requiring only one element from the group, not A plus N, or B plus N, etc.

1-12. (canceled)

13. A method of controlling distribution of metal recovery from a complex inorganic source between a first metal and a second metal, comprising:
contacting the complex inorganic source comprising the first metal and the second metal with an acid to form a first suspension;
mixing the first suspension for a period of time;
upon completion of the period of time, separating the first suspension into a first filtrate and a first solid residue, wherein the first filtrate comprises the first metal and the second metal;
contacting the first filtrate with a first precipitating agent to form a second suspension;
separating the second suspension into a second filtrate and a second solid residue, wherein the second solid residue comprises a portion of the first metal;
contacting the second filtrate with a second precipitating agent to form a third suspension; and
separating the third suspension into a third filtrate and a third solid residue comprising a portion of the second metal,
wherein the period of time is selected to provide a desired recovery distribution between the first metal and the second metal, and
wherein the first precipitating agent is selected from the group consisting of an organic acid, oxalic acid, an organic amine, ethanolamine, an ethanolamine salt, ammonia, and an ammonium salt, and wherein the second solid residue comprises an alumina-containing gel.

14. The method of claim 13, wherein the first metal is aluminum and the second metal is calcium.

15. The method of claim 13, wherein the acid has a pKa below 5.

16. The method of claim 13, wherein the period of time is from 1 minute to 2 hours, and wherein the desired recovery distribution is skewed towards the first metal.

17. The method of claim 13, wherein the period of time exceeds 25 minutes, and wherein the desired recovery distribution is skewed towards the second metal.

18. The method of claim 13, wherein the second precipitating agent is selected from the group consisting of CO₂, carbonic acid, a carbonate salt, a bicarbonate salt, a phosphate salt, a sulfate salt, and oxalic acid.

19. The method of claim 13, wherein separation is performed by at least one of settling, decanting, centrifugation, use of a cyclone separator, and filtration.

20. The method of claim 13, wherein the steps of contacting, mixing, and separating are performed sequentially in a single reaction enclosure.

21. The method of claim 13, wherein the steps of contacting, mixing, and separating are performed sequentially in two or more reaction enclosures.

22. The method of claim 13, wherein the first solid residue is additionally processed to recover additional metals that are different from the first and second metals.

23. The method of claim 13, wherein the complex inorganic source is an industrial waste.

24. The method of claim 23, wherein the industrial waste is selected from the group consisting of blast furnace slag, ladle slag, basic oxygen furnace slag, desulfurization slag, and aluminum-rich ores and wastes.
